(19) United States
(12) Patent Application Publication
(10) Pub. No.: US 2026/0253532 A1
(43) Pub. Date: Aug. 27, 2026

(54) PIXEL CIRCUIT AND DISPLAY APPARATUS INCLUDING THE SAME

(71) Applicant: Samsung Display Co., Ltd., Yongin-si (KR)

(72) Inventors: MINWOO BYUN, Yongin-si (KR); SUNGHWAN KO, Yongin-si (KR); TAEUNG PARK, Yongin-si (KR); Donghwan Jeon, Yongin-si (KR); Jihoon Ha, Yongin-si (KR)

(21) Appl. No.: 19/534,395

(22) Filed: Feb. 9, 2026

(30) Foreign Application Priority Data
Feb. 26, 2025 (KR) 10-2025-0024796

(51) Int. Cl. G09G 3/32

(52) U.S. Cl. CPC G09G 3/32; G09G 2300/0819; G09G 2310/08; G09G 2330/021

(57) ABSTRACT

Provided is a pixel circuit including a first transistor between a first voltage line and a light-emitting element, a second transistor between a data line and a first node driven based on a first signal, a third transistor between a reference voltage line and the first node driven based on a second signal, a fourth transistor between an initialization voltage line and an anode of the light-emitting element driven based on a third signal, a fifth transistor between the first voltage line and the first transistor driven based on an emission control signal, a sixth transistor between the first transistor and the light-emitting element driven based on the emission control signal, a seventh transistor between the first transistor and the initialization voltage line driven based on the third signal, and an eighth transistor between the first voltage line and the first transistor driven based on the second signal.

### CROSS-REFERENCE TO RELATED APPLICATION

The present application claims priority to, and the benefit of, Korean Patent Application No. 10-2025-0024796, filed on February 26, 2025, in the Korean Intellectual Property Office, the entire disclosure of which is incorporated herein by reference.

### BACKGROUND

### Field

The present disclosure relates to a pixel circuit and a display apparatus including the same.

### Description of the Related Art

A pixel emits light based on a data voltage, and includes a transistor that controls driving of the pixel (e.g., thin film transistor (TFT)). A display apparatus may display images in a sequential emission method in which pixels sequentially emit light in row units, or a simultaneous emission method in which entire pixels emit light concurrently or substantially simultaneously after finishing data writing sequentially.

### SUMMARY

One or more embodiments of the present disclosure provide a pixel circuit and a display apparatus including the same. It will be appreciated by one of ordinary skill in the art that the aspects that could be achieved with the present disclosure are not limited to what has been particularly described above and other aspects of the present disclosure will be more clearly understood from the following detailed description and embodiments of the present disclosure. Also, it will be readily understood that the aspects of the present disclosure are realized by the means and combinations thereof set forth in the appended claims.

According to one or more embodiments of the present disclosure, a pixel circuit includes a first transistor connected between a first power voltage line and a light-emitting element, a second transistor connected between a data line and a first node, and configured to be driven based on a first gate signal, a third transistor connected between a reference voltage line and the first node, and configured to be driven based on a second gate signal, a fourth transistor connected between an initialization voltage line and an anode of the light-emitting element, and configured to be driven based on a third gate signal, a fifth transistor connected between the first power voltage line and the first transistor, and configured to be driven based on an emission control signal, a sixth transistor connected between the first transistor and the light-emitting element, and configured to be driven based on the emission control signal, a seventh transistor connected between the first transistor and the initialization voltage line, and configured to be driven based on the third gate signal, and an eighth transistor connected between the first power voltage line and the first transistor, and configured to be driven based on the second gate signal.

The pixel may further include a first capacitor connected to a first gate terminal of the first transistor and to a second terminal of the first transistor, and a second capacitor connected to the first power voltage line and to a second gate terminal of the first transistor.

In a first section, the third transistor and the eighth transistor may be configured to be turned on based on the second gate signal, and the fourth transistor and the seventh transistor may be configured to be turned on based on the third gate signal.

In a first section, the fourth transistor and the seventh transistor may be configured to be turned on based on the third gate signal, and the third transistor and the eighth transistor may be configured to be in turned-off states.

In a second section, the third transistor and the eighth transistor may be configured to be turned on based on the second gate signal.

In a third section, the second transistor may be configured to be turned on based on the first gate signal.

In a fourth section, the fourth transistor and the seventh transistor may be configured to be turned on based on the third gate signal.

In a fifth section and in a sixth section, the fourth transistor and the seventh transistor may be configured to be turned on based on the third gate signal.

According to one or more other embodiments of the present disclosure, a display apparatus includes a display unit including pixels respectively connected to corresponding scan lines, to corresponding emission control lines, and to corresponding data lines, a scan driver configured to supply scan signals respectively through the scan lines, an emission control driver configured to supply emission control signals respectively through the emission control lines, a data driver configured to supply data voltages respectively through the data lines, and a power supplier configured to supply voltages to the pixels, wherein the pixels include a first transistor connected between a first power voltage line and a light-emitting element, a second transistor connected between one of the data lines and a first node, and configured to be driven based on a first gate signal, a third transistor connected between a reference voltage line and the first node, and configured to be driven based on a second gate signal, a fourth transistor connected between an initialization voltage line and an anode of the light-emitting element, and configured to be driven based on a third gate signal, a fifth transistor connected between the first power voltage line and the first transistor, and configured to be driven based on one of the emission control signals, a sixth transistor connected between the first transistor and the light-emitting element, and configured to be driven based on the one of the emission control signals, a seventh transistor connected between the first transistor and the initialization voltage line, and configured to be driven based on the third gate signal, and an eighth transistor connected between the first power voltage line and the first transistor, and configured to be driven based on the second gate signal.

The pixels may further include a first capacitor connected to a first gate terminal of the first transistor and to a second terminal of the first transistor, and a second capacitor connected to the first power voltage line and to a second gate terminal of the first transistor.

In a first section, the third transistor and the eighth transistor may be configured to be turned on based on the second gate signal, and the fourth transistor and the seventh transistor may be configured to be turned on based on the third gate signal.

In a first section, the fourth transistor and the seventh transistor may be configured to be turned on based on the third gate signal, and the third transistor and the eighth transistor may be configured to be in turned-off states.

In a second section, the third transistor and the eighth transistor may be configured to be turned on based on the second gate signal.

In a third section, the second transistor may be configured to be turned on based on the first gate signal.

In a fourth section, the fourth transistor and the seventh transistor may be configured to be turned on based on the third gate signal.

In a fifth section and a sixth section, the fourth transistor and the seventh transistor may be configured to be turned on based on the third gate signal.

According to one or more other embodiments of the present disclosure, an electronic device includes a memory, a processor configured to execute an application stored in the memory, and a display module configured to receive and to process an image data signal and configured to output image information, and including a first transistor connected between a first power voltage line and a light-emitting element, a second transistor connected between a data line and a first node, and configured to be driven based on a first gate signal, a third transistor connected between a reference voltage line and the first node, and configured to be driven based on a second gate signal, a fourth transistor connected between an initialization voltage line and an anode of the light-emitting element, and configured to be driven based on a third gate signal, a fifth transistor connected between the first power voltage line and the first transistor, and configured to be driven based on an emission control signal, a sixth transistor connected between the first transistor and the light-emitting element, and configured to be driven based on the emission control signal, a seventh transistor connected between the first transistor and the initialization voltage line, and configured to be driven based on the third gate signal, and an eighth transistor connected between the first power voltage line and the first transistor, and configured to be driven based on the second gate signal.

The display module may further include a first capacitor connected to a first gate terminal of the first transistor and to a second terminal of the first transistor, and a second capacitor connected to the first power voltage line and to a second gate terminal of the first transistor.

In a first section, the third transistor and the eighth transistor may be configured to be turned on based on the second gate signal, and the fourth transistor and the seventh transistor may be configured to be turned on based on the third gate signal.

In a first section, the fourth transistor and the seventh transistor may be configured to be turned on based on the third gate signal, and the third transistor and the eighth transistor may be configured to be in turned-off states.

Other aspects than those described above will become apparent from the following detailed description of the drawings, claims, and disclosure.

### BRIEF DESCRIPTION OF THE DRAWINGS

The above and other aspects of certain embodiments of the disclosure will be more apparent from the following description taken in conjunction with the accompanying drawings in which:

FIG. 1 is a block diagram of an electronic device according to one or more embodiments;

FIG. 2 is a diagram schematically showing electronic devices according to one or more embodiments;

FIG. 3 is a block diagram of a display apparatus according to one or more embodiments of the present disclosure;

FIG. 4 is a pixel circuit diagram according to the related art;

FIG. 5 is a pixel circuit diagram according to one or more embodiments of the present disclosure;

FIGS. 6A and 6B are timing diagrams of signals for driving the pixel circuit of FIG. 5; and

FIGS. 7A and 7B are timing diagrams of signals for driving the pixel circuit of FIG. 5, according to one or more other embodiments of the present disclosure.

### DETAILED DESCRIPTION

Aspects of some embodiments of the present disclosure and methods of accomplishing the same may be understood more readily by reference to the detailed description of embodiments and the accompanying drawings. The described embodiments are provided as examples so that this disclosure will be thorough and complete, and will fully convey the aspects of the present disclosure to those skilled in the art. Accordingly, processes, elements, and techniques that are redundant, that are unrelated or irrelevant to the description of the embodiments, or that are not necessary to those having ordinary skill in the art for a complete understanding of the aspects of the present disclosure may be omitted. Unless otherwise noted, like reference numerals, characters, or combinations thereof denote like elements throughout the attached drawings and the written description, and thus, repeated descriptions thereof may be omitted.

The described embodiments may have various modifications and may be embodied in different forms, and should not be construed as being limited to only the illustrated embodiments herein. The use of “can,” “may,” or “may not” in describing an embodiment corresponds to one or more embodiments of the present disclosure.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

In the drawings, the relative sizes of elements, layers, and regions may be exaggerated for clarity and/or descriptive purposes. In other words, because the sizes and thicknesses of elements in the drawings are arbitrarily illustrated for convenience of description, the disclosure is not limited thereto. Various embodiments may be described herein with reference to sectional illustrations that are schematic illustrations of embodiments and/or intermediate structures. As such, variations from the shapes of the illustrations as a result of, for example, manufacturing techniques and/or tolerances, are to be expected. Further, specific structural or functional descriptions disclosed herein are merely illustrative for the purpose of describing embodiments according to the concept of the present disclosure. Thus, embodiments disclosed herein should not be construed as limited to the illustrated shapes of elements, layers, or regions, but are to include deviations in shapes that result from, for instance, manufacturing.

It will be understood that when an element, layer, region, or component (e.g., an apparatus, a device, a circuit, a wire, an electrode, a terminal, a conductive film, etc.) is referred to as being “formed on,” “on,” “connected to,” or “(operatively, functionally, or communicatively) coupled to” another element, layer, region, or component, it can be directly formed on, on, connected to, or coupled to the other element, layer, region, or component, or indirectly formed on, on, connected to, or coupled to the other element, layer, region, or component such that one or more intervening elements, layers, regions, or components may be present. In addition, this may collectively mean a direct or indirect coupling or connection and an integral or non-integral coupling or connection.

For example, when a layer, region, or component is referred to as being “electrically connected” or “electrically coupled” to another layer, region, or component, it can be directly electrically connected or coupled to the other layer, region, and/or component or one or more intervening layers, regions, or components may be present. The one or more intervening components may include a switch, a transistor, a resistor, an inductor, a capacitor, a diode and/or the like. Accordingly, a connection is not limited to the connections illustrated in the drawings or the detailed description and may also include other types of connections. In describing embodiments, an expression of connection indicates electrical connection unless explicitly described to be direct connection, and “directly connected/directly coupled,” or “directly on,” refers to one component directly connecting or coupling another component, or being on another component, without an intermediate component.

Meanwhile, other expressions describing relationships between components, such as “between,” “immediately between” or “adjacent to” and “directly adjacent to,” may be construed similarly. It will be understood that when an element or layer is referred to as being “between” two elements or layers, it can be the only element or layer between the two elements or layers, or one or more intervening elements or layers may also be present.

For the purposes of this disclosure, expressions such as “at least one of,” or “any one of,” or “one or more of” when preceding a list of elements, modify the entire list of elements and do not modify the individual elements of the list. For example, “at least one of X, Y, and Z,” “at least one of X, Y, or Z,” “at least one selected from the group consisting of X, Y, and Z,” and “at least one selected from the group consisting of X, Y, or Z” may be construed as X only, Y only, Z only, any combination of two or more of X, Y, and Z, such as, for instance, XYZ, XY, YZ, and XZ, or any variation thereof. Similarly, the expressions “at least one of A and B” and “at least one of A or B” may include A, B, or A and B. As used herein, “or” generally means “and/or,” and the term “and/or” includes any and all combinations of one or more of the associated listed items. For example, the expression “A and/or B” may include A, B, or A and B. Similarly, expressions such as “at least one of,” “a plurality of,” “one of,” and other prepositional phrases, when preceding a list of elements, modify the entire list of elements and do not modify the individual elements of the list. When "C to D" is stated, it means C or more and D or less, unless otherwise specified.

It will be understood that, although the terms “first,” “second,” “third,” etc., may be used herein to describe various elements, components, regions, layers and/or sections, these elements, components, regions, layers and/or sections should not be limited by these terms. These terms do not correspond to a particular order, position, or superiority, and are only used to distinguish one element, member, component, region, area, layer, section, or portion from another element, member, component, region, area, layer, section, or portion. Thus, a first element, component, region, layer, or section described below could be termed a second element, component, region, layer, or section, without departing from the spirit and scope of the present disclosure. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-category (or first-set),” “second-category (or second-set),” etc., respectively.

The terminology used herein is for the purpose of describing embodiments only and is not intended to be limiting of the present disclosure. As used herein, the singular forms “a” and “an” are intended to include the plural forms as well, while the plural forms are also intended to include the singular forms, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

When one or more embodiments may be implemented differently, a specific process order may be performed differently from the described order. For example, two consecutively described processes may be performed substantially at the same time or performed in an order opposite to the described order.

As used herein, the terms “substantially,” “about,” “approximately,” and similar terms are used as terms of approximation and not as terms of degree, and are intended to account for the inherent deviations in measured or calculated values that would be recognized by those of ordinary skill in the art. For example, “substantially” may include a range of +/- 5 % of a corresponding value. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ± 30%, 20%, 10%, 5% of the stated value. Further, the use of “may” when describing embodiments of the present disclosure refers to “one or more embodiments of the present disclosure.” Furthermore, the expression “being the same” may mean “being substantially the same.” In other words, the expression “being the same” may include a range that can be tolerated by those of ordinary skill in the art. The other expressions may also be expressions from which “substantially” has been omitted.

In some embodiments well-known structures and devices may be described in the accompanying drawings in relation to one or more functional blocks (e.g., block diagrams), units, and/or modules to avoid unnecessarily obscuring various embodiments. Those skilled in the art will understand that such block, unit, and/or module are/is physically implemented by a logic circuit, an individual component, a microprocessor, a hard wire circuit, a memory element, a line connection, and other electronic circuits. This may be formed using a semiconductor-based manufacturing technique or other manufacturing techniques. The block, unit, and/or module implemented by a microprocessor or other similar hardware may be programmed and controlled using software to perform various functions discussed herein, optionally may be driven by firmware and/or software. In addition, each block, unit, and/or module may be implemented by dedicated hardware, or a combination of dedicated hardware that performs some functions and a processor (for example, one or more programmed microprocessors and related circuits) that performs a function different from those of the dedicated hardware. In addition, in some embodiments, the block, unit, and/or module may be physically separated into two or more interact individual blocks, units, and/or modules without departing from the scope of the present disclosure. In addition, in some embodiments, the block, unit and/or module may be physically combined into more complex blocks, units, and/or modules without departing from the scope of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

The display apparatus according to one or more embodiments may be applied to various electronic devices. An electronic device according to one or more embodiments includes the display apparatus stated above, and may further include a module or a device having additional functions in addition to the display apparatus.

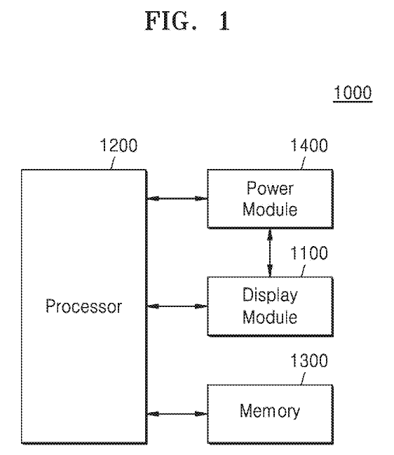

FIG. 1 is a block diagram of an electronic device according to one or more embodiments. Referring to FIG. 1, an electronic device 1000 according to one or more embodiments may include a display module 1100, a processor 1200, a memory 1300, and a power module 1400.

The processor 1200 may include at least one of a central processing unit (CPU), an application processor (AP), a graphic processing unit (GPU), a communication processor (CP), an image signal processor (ISP), and a controller.

The memory 1300 may store data information that is suitable in operations of the processor 1200 or the display module 1100. When the processor 1200 executes an application stored in the memory 1300, an image data signal and/or an input control signal is transferred to the display module 1100, and the display module 1100 processes the transferred signal and outputs image information through a display screen.

The power module 1400 may include a power supply module such as a power adaptor or a battery device, and a power conversion module that converts the power supplied by the power supply module and generates electric power that is suitable for the operations of the electronic device 1000.

At least one of components in the electronic device 1000 may be included in the display apparatus. Also, some of individual modules functionally included in one module may be included in the display apparatus and some other modules may be provided separately from the display apparatus. For example, the display apparatus includes the display module 1100, and the processor 1200, the memory 1300, and the power module 1400 may be provided in the form of other devices in the electronic device 1000, not the display apparatus.

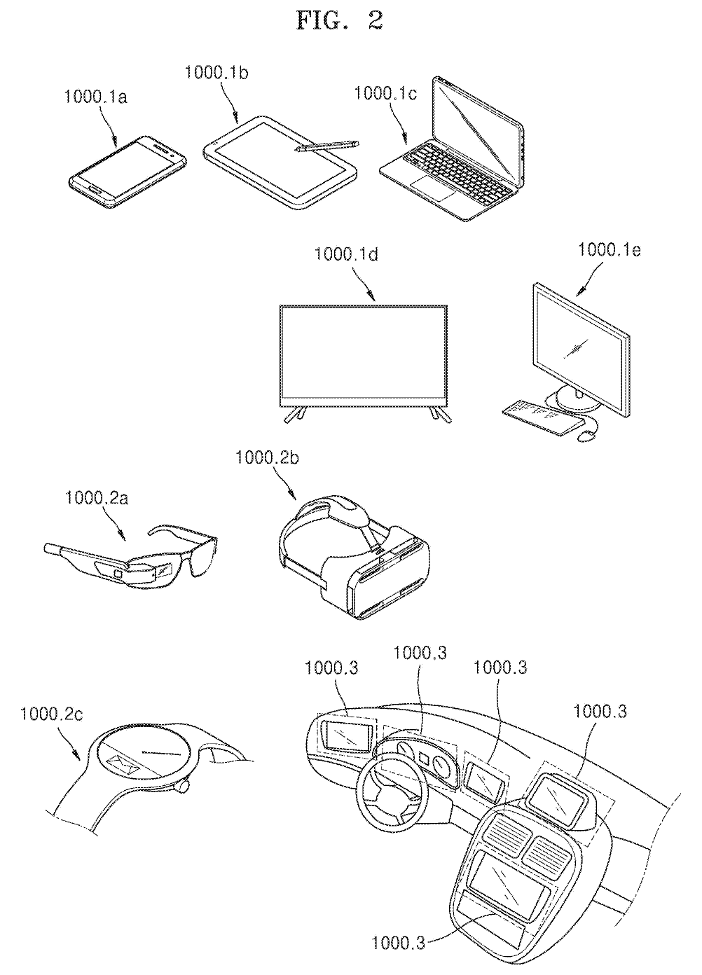

FIG. 2 is a diagram schematically showing electronic devices according to one or more embodiments.

Referring to FIG. 2, various electronic devices to which the display apparatus according to one or more embodiments is applied may include image displaying electronic devices, such as a smartphone 1000_1a, a tablet personal computer (PC) 1000_1b, a laptop computer 1000_1c, a television (TV) 1000_1d, and a desk monitor 1000_1e, and moreover, wearable electronic devices, such as smart glasses 1000_2a, a head-mounted display 1000_2b, a smart watch 1000_2c, etc. including a display module, a vehicle electronic device 1000_3 including a display module, such as a dashboard of a vehicle, a center fascia, a center information display (CID) arranged on the dash board, a room-mirror display, etc.

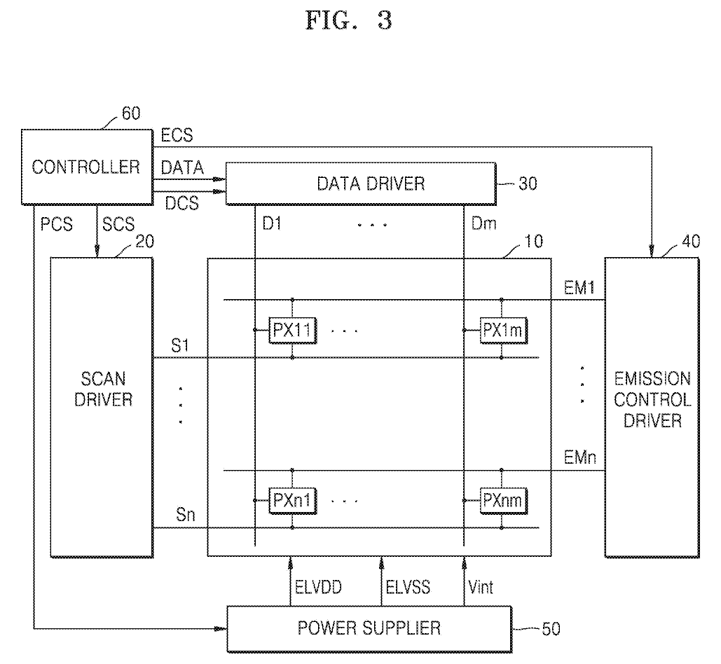

FIG. 3 is a block diagram of a display apparatus according to one or more embodiments of the present disclosure.

Referring to FIG. 3, the display apparatus according to one or more embodiments of the present disclosure may include a display unit 10 including a plurality of pixels PX11 to PXnm, a scan driver 20, a data driver 30, an emission control driver 40, a power supplier 50, and a controller 60.

In one or more embodiments, each of the plurality of pixels PX11 to PXnm may be connected to at least one corresponding scan line from among a plurality of scan lines S1 to Sn connected to the display unit 10, at least one corresponding emission control line from among a plurality of emission control lines EM1 to EMn, and at least one corresponding data line (e.g., data voltage line) from among a plurality of data lines D1 to Dm.

In one or more embodiments, each of the plurality of pixels PX11 to PXnm may be connected to a power supply line connected to the display unit 10, and may be supplied with the power for operating the pixels (e.g., a first power voltage ELVDD, a second power voltage ELVSS, an initialization voltage Vint, etc.).

In one or more embodiments, the display unit 10 may include the plurality of pixels PX11 to PXnm arranged in a certain form (e.g., in a matrix form).

In one or more embodiments, each of the plurality of pixels PX11 to PXnm may emit light of a certain luminance due to a driving current supplied to a light-emitting device according to a data voltage transferred through the plurality of data lines D1 to Dm.

In addition, the display unit 10 may be referred to as a display panel. In the present disclosure, the display panel may be implemented as one of a liquid crystal display (LCD), light-emitting diode (LED) display, organic LED (OLED) display, active-matrix OLED (AMOLED) display, electrochromic display (ECD), digital mirror device (DMD), actuated mirror device (AMD), Grating Light Valve (GLV), Plasma Display Panel (PDP), Electro Luminescent Display (ELD), and vacuum fluorescent display (VFD), and may be implemented as any other type of flat panel display or flexible display.

In one or more embodiments, the scan driver 20 may generate and transfer scan signals corresponding respectively to the pixels through the plurality of scan lines S1 to Sn. That is, the scan driver 20 may transfer the scan signal to each of the plurality of pixels included in each row via the corresponding scan line. For example, the scan driver 20 may receive a scan-driving control signal SCS from the controller 60 to generate a plurality of scan signals, and may supply the scan signals sequentially to the plurality of scan lines S1 to Sn connected to respective rows.

In one or more embodiments, the data driver 30 may transfer data signals respectively to the pixels via the plurality of data lines D1 to Dm. For example, the data driver 30 may receive a data-driving control signal DCS from the controller 60 and supply data signals to the plurality of data lines D1 to Dm respectively connected to the plurality of pixels PX11 to PXnm included in respective rows.

In one or more embodiments, the emission control driver 40 may be connected to the plurality of emission control lines EM1 to EMn connected to the display unit 10 including the plurality of pixels PX11 to PXnm arranged in the matrix form. That is, the plurality of emission control lines EM1 to EMn that respectively face the plurality of pixels in a row direction and extend nearly parallel to each other may connect the plurality of pixels to the emission control driver 40.

In one or more embodiments, the emission control driver 40 may generate and transfer emission control signals respectively corresponding to the pixels via the plurality of emission control lines EM1 to EMn. Each pixel receiving the emission control signal may be controlled to emit the image according to an image data signal, in response to the control from the emission control signal. That is, in response to the emission control signal transferred through the corresponding emission control line, operation of the emission control transistor included in each pixel is controlled, and accordingly, the light-emitting element connected to the emission control transistor may emit or may not emit light at the luminance according to the driving current corresponding to the data signal.

In one or more embodiments, the power supplier 50 may supply the first power voltage ELVDD, the second power voltage ELVSS, a first initialization voltage Vint, a second initialization voltage Vaint, etc. to each of the pixels of the display unit 10. For example, the first power voltage ELVDD may be a certain high-level voltage, and the second power voltage ELVSS may be a voltage less than the first power voltage ELVDD or a ground voltage. For example, the initialization voltage Vint may be set as a voltage value that is less than or equal to the second power voltage ELVSS.

In addition, voltage values of the first power voltage ELVDD, the second power voltage ELVSS, and the initialization voltage Vint are not particularly restricted, but the voltage values may be set or controlled according to the control from the power control signal PCS transferred from the controller 60.

In one or more embodiments, the controller 60 may convert a plurality of image signals transferred from the outside into a plurality of image data signals DATA and then may transfer the signals to the data driver 30. Also, in one or more embodiments, the controller 60 may receive a vertical synchronization signal, a horizontal synchronization signal, and a clock signal, and may generate control signals for controlling the driving of the scan driver 20, the emission control driver 40, and the data driver 30, and may transfer the respective signals to the scan driver 20, the emission control driver 40, and the data driver 30. That is, the controller 60 may generate and transfer a scan-driving control signal SCS for controlling the scan driver 20, an emission-driving control signal ECS for controlling the operation of the emission control driver 40, and a data-driving control signal DCS for controlling the data driver 30. Also, the controller 60 may generate a power control signal PCS for controlling the driving of the power supplier 50, and then may transfer the generated signal to the power supplier 50.

In one or more embodiments, the display apparatus may further include a reference voltage generator. For example, the reference voltage generator may generate a reference voltage VREF based on the control signal input from the controller 60. The reference voltage generator may provide the data driver 30 with the reference voltage VREF. The reference voltage VREF may have a value corresponding to each data signal DATA. In addition, the reference voltage generator may be arranged in the controller 60 or in the data driver 30.

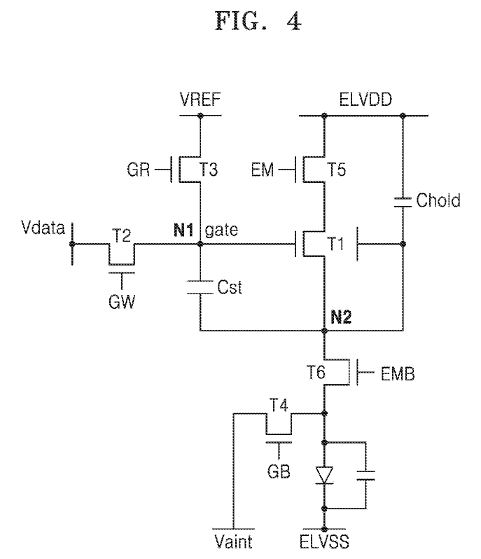

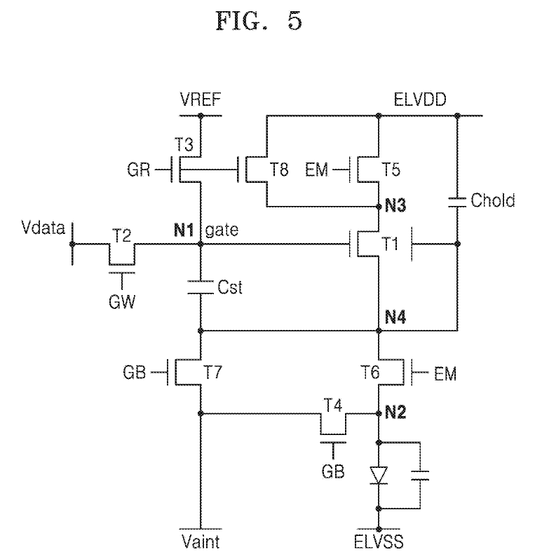

In one or more embodiments, the data driver 30 may receive the data-driving control signal DCS from the controller 60, and may receive the reference voltage VREF from the reference voltage generator. The data driver 30 may convert the data signal DATA into a data voltage Vdata (e.g., see FIGS. 4 and 5) of an analog type by using the reference voltage VREF (e.g., see FIGS. 4 and 5). For example, the data driver 30 may output the data voltage Vdata to the data line.

FIG. 4 is a pixel circuit diagram according to the related art.

Referring to FIG. 4, a circuit diagram of a pixel circuit including a light-emitting element is shown. The pixel circuit shown in FIG. 4 may include six transistors T1 to T6 and two capacitors Cst and Chold.

A first capacitor Cst may be a storage capacitor performing a function of storing the data voltage of the pixel, and a second capacitor Chold may be a holding capacitor that assists the data to be maintained, so as to stabilize the pixel until the data is switched to data of next frame.

In addition, a first emission control signal EM, a second emission control signal EMB, a first gate signal GW, a second gate signal GR, and a third gate signal GB may be supplied to the pixel circuit according to the related art shown in FIG. 4. The pixel circuit according to the related art requires five driver circuits for supplying the signals, resulting in increase in the power consumption.

To address the above issue, the pixel (or pixel circuit) according to one or more embodiments of the present disclosure is described below.

FIG. 5 is a pixel circuit diagram according to one or more embodiments of the present disclosure.

Referring to FIG. 5, a circuit diagram of a pixel circuit including a light-emitting element is shown. Referring to FIG. 5, the pixel circuit according to one or more embodiments of the present disclosure may include eight transistors T1 to T8 and two capacitors Cst and Chold.

A first terminal and a second terminal in each of first to eighth transistors T1 to T8 may each be a source terminal or a drain terminal according to the voltage thereof. For example, according to the voltages of the first terminal and the second terminal, the first terminal may be a drain terminal, and the second terminal may be a source terminal. In another example, according to the voltages of the first terminal and the second terminal, the first terminal may be a source terminal and the second terminal may be a drain terminal.

Referring to FIG. 5, a first transistor T1 is shown, and the first transistor T1 is turned on/off according to a signal applied to a gate terminal and adjusts a current for light emission from the light-emitting element. The first transistor T1 may be referred to as a driving transistor.

In one or more embodiments, the first transistor T1 may be connected between the first power voltage ELVDD line and the light-emitting element, and may be driven based on the signal applied to the gate terminal thereof. The first transistor T1 may include two gate terminals. The first transistor T1 may include a first gate terminal connected to a first node N1, and a second gate terminal connected to one end of the second capacitor Chold.

The first terminal of the first transistor T1 may be connected to a third node N3. The second terminal of the first transistor T1 may be connected to a fourth node N4. Also, the first transistor T1 may be driven according to the signal applied to the gate terminal (e.g., a first gate terminal).

In one or more embodiments, the second transistor T2 may be connected between the data voltage Vdata line and the first node N1, and may be driven based on the first gate signal GW. The first terminal of the second transistor T2 may be connected to the data voltage Vdata line. The second terminal of the second transistor T2 may be connected to the first node N1. The second transistor T2 may be turned on/off according to the first gate signal GW, and may adjust the supply of the data voltage Vdata.

In one or more embodiments, the third transistor T3 may be connected between the reference voltage VREF line and the first node N1, and may be driven by the second gate signal GR. The first terminal of the third transistor T3 may be connected to the reference voltage VREF line. The second terminal of the third transistor T3 may be connected to the first node N1. The third transistor T3 is turned on/off according to the second gate signal GR, and adjusts the supply of the reference voltage VREF.

In one or more embodiments, the fourth transistor T4 may be connected between the initialization voltage Vaint line and an anode of the light-emitting element, and may be driven by the third gate signal GB. The first terminal of the fourth transistor T4 may be connected to the initialization voltage Vaint line. The second terminal of the fourth transistor T4 may be connected to the second node N2. Here, the second node N2 may be a node corresponding to the anode of the light-emitting element. The fourth transistor is turned on/off according to the third gate signal GB, and may supply the initialization voltage Vaint.

In one or more embodiments, the fifth transistor T5 is connected between the first power voltage ELVDD line and the first transistor T1, and may be driven based on the emission control signal EM. A first terminal of the fifth transistor T5 may be connected to the first power voltage ELVDD line. A second terminal of the fifth transistor T5 may be connected to the third node N3. Here, the third node N3 may be a node to which the first terminal of the first transistor T1 is connected. The fifth transistor T5 may be turned on/off according to the emission control signal EM.

In one or more embodiments, the sixth transistor T6 may be connected between the first transistor T1 and the light-emitting element, and may be driven based on the emission control signal EM. A first terminal of the sixth transistor T6 may be connected to the fourth node N4. Here, the fourth node N4 may be a node to which the second terminal of the first transistor T1 is connected. A second terminal of the sixth transistor T6 may be connected to the second node N2. Here, the second node N2 may be a node to which the anode of the light-emitting element is connected. The sixth transistor T6 may be turned on/off according to the emission control signal EM.

In one or more embodiments, the seventh transistor T7 may be connected to the first transistor T1 and the initialization voltage Vaint line, and may be driven based on the third gate signal GB. A first terminal of the seventh transistor T7 may be connected to the fourth node N4. Here, as described above, the fourth node N4 may be a node to which the second terminal of the first transistor T1 is connected. A second terminal of the seventh transistor T7 may be connected to the initialization voltage Vaint line. The seventh transistor T7 is turned on/off according to the third gate signal GB and may supply the initialization voltage Vaint.

In one or more embodiments, the eighth transistor T8 may be connected between the first power voltage ELVDD line and the first transistor T1, and may be driven based on the second gate signal GR. A first terminal of the eighth transistor T8 may be connected to the first power voltage EL VDD line. A second terminal of the eighth transistor T8 may be connected to the third node N3. Here, as described above, the third node N3 may be a node to which the first terminal of the first transistor T1 is connected. The eighth transistor T8 may be turned on/off according to the second gate signal GR.

Referring to FIG. 5, the pixel circuit according to one or more embodiments of the present disclosure may include the first capacitor Cst and the second capacitor Chold.

As described above with reference to the pixel circuit diagram according to the related art shown in FIG. 4, the first capacitor Cst may be a storage capacitor performing a function of storing the data voltage of the pixel, and the second capacitor Chold may be a holding capacitor that assists the data to be maintained so as to stabilize the pixel until switched to data of a next frame.

The first capacitor Cst may be connected to the first gate terminal of the first transistor T1 and to the second terminal of the first transistor T1. A first terminal of the first capacitor Cst may be connected to the first terminal of the first transistor T1. A second terminal of the first capacitor Cst may be connected to the fourth node N4 that is connected to the first transistor T1. As described above, the fourth node N4 may be connected to the second terminal of the first transistor T1.

The second capacitor Chold may be connected to the first power voltage ELVDD line and the second gate terminal of the first transistor T1. A first terminal of the second capacitor Chold may be connected to the first power voltage ELVDD line. A second terminal of the second capacitor Chold may be connected to the second gate terminal of the first transistor T1.

Referring to FIG. 5, in one or more embodiments, the light-emitting element may be connected to the fourth transistor T4 and the sixth transistor T6. In more detail, the anode of the light-emitting element may be connected to the second terminal of the fourth transistor T4 and the second terminal of the sixth transistor T6. A cathode of the light-emitting element may be connected to a second power voltage ELVSS terminal.

Unlike the pixel circuit according to the related art as shown in FIG. 4, referring to the pixel circuit diagram according to one or more embodiments of the present disclosure shown in FIG. 5, the pixel circuit according to one or more embodiments of the present disclosure may additionally include the seventh transistor T7 and/or the eighth transistor T8.

The emission control signal EM, the first gate signal GW, the second gate signal GR, and the third gate signal GB may be supplied to the pixel circuit according to one or more embodiments of the present disclosure shown in FIG. 5.

This denotes that kinds of supplied signals are reduced as compared with those of the pixel circuit according to the related art shown in FIG. 4, and four driver circuits may be suitable for driving the pixel circuit according to one or more embodiments of the present disclosure. As such, the circuit according to the present disclosure may reduce the power consumption.

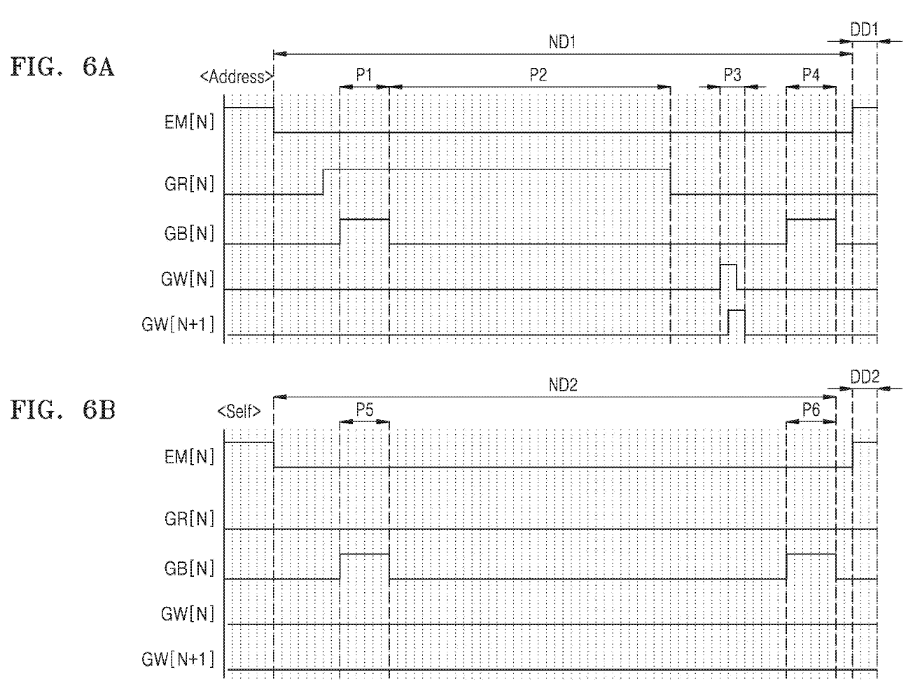

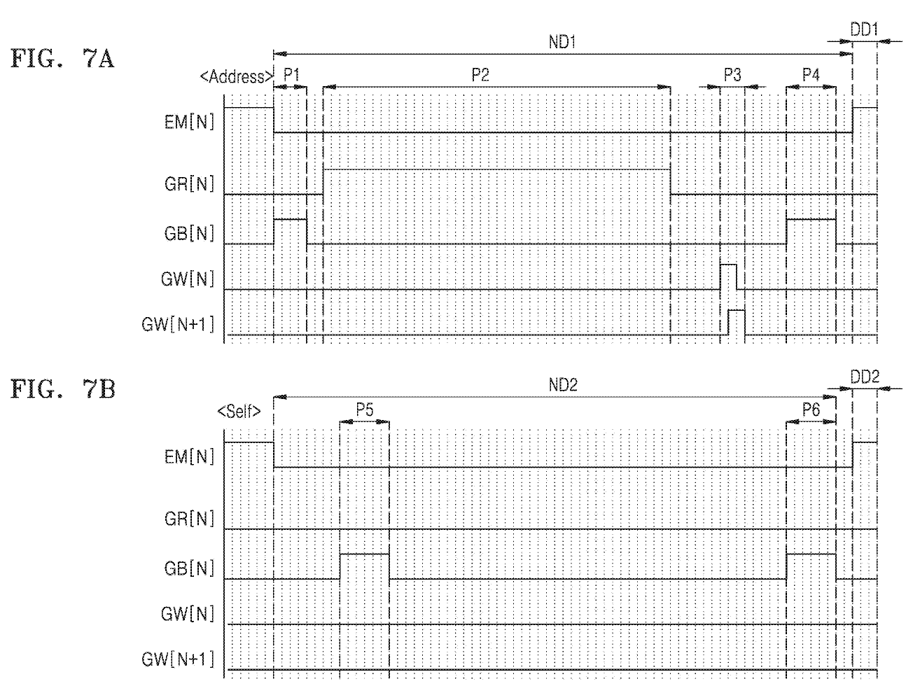

Aspects of the pixel circuit and the display apparatus or electronic device including the pixel circuit according to one or more embodiments of the present disclosure shown in FIG. 5 are clarified in the descriptions about detailed operations provided with reference to FIGS. 6 and 7.

FIGS. 6A and 6B are timing diagrams of signals for driving the pixel circuit of FIG. 5.

Referring to FIGS. 6A and 6B, changes in the emission control signal EM, the first gate signal GW, the second gate signal GR, and the third gate signal GB that are applied to the pixel circuit of FIG. 5 during one unit section (e.g., a single frame section) are shown.

In one or more embodiments, one frame corresponding to one unit section may include a first scanning period and a second scanning period. For example, one frame may include one first scanning period and one second scanning period. In another example, one frame may include one first scanning period or one or more second scanning periods. The first scanning period may denote an address scan period, and the second scanning period may denote a self-scan period.

In addition, FIG. 6A shows a timing diagram during one scanning period. Also, FIG. 6B shows a timing diagram during one second scanning period.

Hereinafter, timing diagrams of the signals for driving the pixel circuit of FIG. 5 during the first scanning period shown in FIG. 6A are described below.

In one or more embodiments, the first scanning period may include a first non-emission period ND1 and a first emission period DD1. Here, the first non-emission period ND1 may include first to fourth sections P1, P2, P3, and P4.

The first section P1 may be a first initialization section. Referring to the values of the signals shown in the first section P1 of FIG. 6A, the second gate signal GR and the third gate signal GB have high-level voltages. Due to the second gate signal GR, the third transistor T3 and the eighth transistor T8 may be turned on. Also, due to the third gate signal GB, the fourth transistor T4 and the seventh transistor T7 may be turned on.

The fourth node N4 may be initialized due to the turned-on seventh transistor T7. In detail, a voltage at the fourth node N4 may be initialized to the initialization voltage Vaint. That is, the second terminal of the first transistor T1 may be initialized to the initialization voltage Vaint.

Due to the turned-on fourth transistor T4, a voltage at the second node N2 may be initialized to the initialization voltage Vaint. As such, the anode of the light-emitting element may be initialized to the initialization voltage Vaint.

The reference voltage VREF may be supplied to the first node N1 due to the turned-on third transistor T3. As such, the reference voltage VREF may be supplied to the first gate terminal of the first transistor T1.

The first power voltage ELVDD may be supplied to the first terminal of the first transistor T1 due to the turned-on eighth transistor T8.

In summary, the first power voltage ELVDD may be supplied to the first terminal of the first transistor T1, the initialization voltage Vaint may be supplied to the second terminal of the first transistor T1, and the reference voltage VREF may be supplied to the first gate voltage of the first transistor T1 in the first section P1. Also, the initialization voltage Vaint may be supplied to the anode of the light-emitting element in the first section P1.

The second section P2 may be a compensation section. Referring to the signal values shown in the second section P2 of FIG. 6A, the second gate signal GR has a high-level voltage. As such, the third transistor T3 and the eighth transistor T8 may be turned on.

Due to the turned-on third transistor T3, the reference voltage VREF may be supplied to the first node N1, and due to the turned-on eighth transistor T8, the first power voltage ELVDD may be supplied to the third node N3.

According to the reference voltage VREF applied to the gate terminal of the first transistor T1, that is, applied to the first node N1, the first power voltage ELVDD applied to the first terminal of the first transistor T1, that is, applied to the third node N3, and the initialization voltage Vaint applied to the second terminal of the first transistor T1 in the first section P1, that is, applied to the fourth node N4, the first transistor T1 may operate in a saturated state, and accordingly, the voltage at the second terminal of the first transistor T1 may follow the voltage of the gate terminal of the first transistor T1. In detail, the second terminal of the first transistor T1 may have a voltage corresponding to VREF-Vth, which is a voltage that is less than the reference voltage VREF by the threshold voltage Vth, the reference voltage VREF being applied to the gate terminal of the first transistor T1. As such, the threshold voltage Vth may be compensated.

The third section P3 may be a data-writing section. Referring to the signal values shown in the third section P3 of FIG. 6A, the first gate signal GW has a high-level voltage. As such, the second transistor T2 may be turned on.

The data voltage Vdata may be supplied to the first node N1 due to the turned-on second transistor T2. That is, the data voltage Vdata may be supplied to the first gate terminal of the first transistor T1. As such, the voltage at the first gate terminal of the first transistor T1 may be changed from the reference voltage VREF to the data voltage Vdata.

As described above, the voltage at the second terminal of the first transistor T1 may follow the voltage at the gate terminal of the first transistor T1, and in detail, the voltage at the second terminal of the first transistor T1 may change proportionally to a variation (Vdata-VREF) in the voltage at the gate terminal of the first transistor T1. The variation in the voltage of the second terminal of the first transistor T1 may be based on a capacity ratio between the first capacitor Cst and the second capacitor Chold.

The fourth section P4 may be a second initialization section. Referring to the signal values in the fourth section P4 shown in FIG. 6A, the third gate signal GB has a high-level voltage. As such, the fourth transistor T4 and the seventh transistor T7 may be turned on.

The initialization voltage Vaint may be supplied to the second node N2 due to the turned-on fourth transistor T4. As such, the initialization voltage Vaint is supplied to the anode terminal of the light-emitting element and the voltage at the anode of the light-emitting element may be initialized to the initialization voltage Vaint.

The initialization voltage Vaint may be supplied to the fourth node N4 due to the turned-on seventh transistor T7. As such, the voltage at the second terminal of the first transistor T1 may be initialized to the initialization voltage Vaint.

The first emission period DD1 may be a section in which a current that flows due to the driving transistor of the pixel circuit is applied to the light-emitting element so that the light-emitting element emits light.

Referring to the signal values in the first emission period DD1 of FIG. 6A, the emission control signal EM has a high-level voltage.

As such, the fifth transistor T5 and the sixth transistor T6 may be turned on. The first power voltage ELVDD may be supplied to the first terminal of the first transistor T1 due to the turned-on fifth transistor T5. As the sixth transistor T6 is turned on, a driving current is supplied to the light-emitting element and the light-emitting element may emit light.

Hereinafter, timing diagrams of the signals for driving the pixel circuit of FIG. 5 during the second scanning period shown in FIG. 6B are described below.

As shown in FIG. 6B, the second scanning period may include a second non-emission period ND2 and a second emission period DD2. Here, the second non-emission period ND2 may include a fifth section P5 and a sixth section P6.

Referring to FIG. 6B, in the fifth section P5 and the sixth section P6, the third gate signal GB has a high-level voltage. As such, the fourth transistor T4 and the seventh transistor T7 may be turned on. The initialization voltage Vaint may be supplied to the second node N2 and the fourth node N4 due to the fourth transistor T4 and the seventh transistor T7 that are turned on. As such, the voltage at the second terminal of the first transistor T1 and the voltage at the anode of the light-emitting element may be initialized to the initialization voltage Vaint.

FIGS. 7A and 7B are timing diagrams of signals for driving the pixel circuit of FIG. 5, according to one or more other embodiments of the present disclosure.

Like the above descriptions provided with reference to FIGS. 6A and 6B, referring to FIGS. 7A and 7B, changes in the emission control signal EM, the first gate signal GW, the second gate signal GR, and the third gate signal GB applied to the pixel circuit of FIG. 5 during one unit section are shown.

Like the above descriptions provided with reference to FIGS. 6A and 6B, in one or more embodiments, one frame may include the first scanning period and the second scanning period. In some embodiments, the first scanning period may denote an address scan period and the second scanning period may denote a self-scan period.

Referring to FIG. 7A, the third gate signal GB in the first section P1 has a high-level voltage. Here, the first section P1 may be an initialization period. As such, the fourth transistor T4 and the seventh transistor T7 may be turned on. In addition, unlike in the first section P1 of FIG. 6A, the third transistor T3 and the eighth transistor T8 may be in turned-off states in the first section P1 of FIG. 7A.

Referring to FIG. 7A, the second gate signal GR in the second section P2 has a high-level voltage. That is, FIG. 7A shows that the third gate signal GB and the second gate signal GR are not concurrently or substantially simultaneously applied.

When the pixel circuit of FIG. 5 is driven based on the timing diagram of FIG. 7A, a current passage connecting from the first power voltage ELVDD line to the initialization voltage Vaint line via the eighth transistor T8, the first transistor T1, and the seventh transistor T7 is not formed, and thus, the likelihood of formation of a short current may be reduced or prevented.

That is, when the pixel circuit of FIG. 5 is driven in the first section P1 shown in FIG. 7A, the eighth transistor T8 is not activated, and the likelihood of the formation of short current may be reduced or prevented, unlike when the pixel circuit of FIG. 5 is driven in the first section P1 shown in FIG. 6A.

Other than the above difference, the timing diagrams shown in FIGS. 6A and 6B and the timing diagrams shown in FIGS. 7A and 7B are shown to be substantially the same. Operations of the signals and circuits in each section included in FIGS. 6A and 6B are described above with reference to FIGS. 6A and 6B, and thus, other detailed descriptions about FIGS. 7A and 7B are omitted.

The transistors included in the pixel circuit according to one or more embodiments of the present disclosure as described above are N-type metal oxide semiconductor field effect transistors (MOSFET), but transistors of P-type MOSFET are also included in various embodiments described in the present disclosure, and the above modification could be easily appreciated by one of ordinary skill in the art.

According to various embodiments of the present disclosure, the number of driver circuits reduces. As such, power consumption may be reduced.

Each of the embodiments described above may be implemented independently, although the structure of each embodiment may be applied in combination to other embodiments.

While the disclosure has been shown and described with reference to embodiments thereof, it will be understood by those of ordinary skill in the art that various changes in form and details may be made therein without departing from the spirit and scope as defined by the following claims. Therefore, the scope sought to be protected of the disclosure shall be defined by the appended claims, with functional equivalents thereof to be included therein.

The implementations shown and described herein are illustrative examples of the embodiments and are not intended to otherwise limit the scope of the embodiments in any way. Moreover, no item or component is essential to the practice of the disclosure unless the element is specifically described as "essential" or "critical".

The singular forms "a," "an" and "the" in the specification of the embodiments, in particular, claims, may be intended to include the plural forms as well. Unless otherwise defined, the ranges defined herein is intended to include values within the range as individually applied and may be considered to be the same as individual values constituting the range in the detailed description. Finally, operations constituting methods may be performed in appropriate order unless explicitly described in terms of order or described to the contrary. Embodiments are not necessarily limited to the order of operations given in the description. The examples or terms used herein are to merely describe embodiments in detail and are not intended to limit the embodiments unless defined by the following claims. Also, those of ordinary skill in the art will readily appreciate that many alternations, combinations, and modifications, may be made according to design conditions and factors within the scope of the appended claims and their equivalents.

What is claimed is:

1. A pixel circuit comprising:
a first transistor connected between a first power voltage line and a light-emitting element;
a second transistor connected between a data line and a first node, and configured to be driven based on a first gate signal;
a third transistor connected between a reference voltage line and the first node, and configured to be driven based on a second gate signal;
a fourth transistor connected between an initialization voltage line and an anode of the light-emitting element, and configured to be driven based on a third gate signal;
a fifth transistor connected between the first power voltage line and the first transistor, and configured to be driven based on an emission control signal;
a sixth transistor connected between the first transistor and the light-emitting element, and configured to be driven based on the emission control signal;
a seventh transistor connected between the first transistor and the initialization voltage line, and configured to be driven based on the third gate signal; and
an eighth transistor connected between the first power voltage line and the first transistor, and configured to be driven based on the second gate signal.

2. The pixel circuit of claim 1, further comprising:
a first capacitor connected to a first gate terminal of the first transistor and to a second terminal of the first transistor; and
a second capacitor connected to the first power voltage line and to a second gate terminal of the first transistor.

3. The pixel circuit of claim 1, wherein, in a first section:
the third transistor and the eighth transistor are configured to be turned on based on the second gate signal; and
the fourth transistor and the seventh transistor are configured to be turned on based on the third gate signal.

4. The pixel circuit of claim 1, wherein, in a first section:
the fourth transistor and the seventh transistor are configured to be turned on based on the third gate signal; and
the third transistor and the eighth transistor are configured to be in turned-off states.

5. The pixel circuit of claim 1, wherein, in a second section, the third transistor and the eighth transistor are configured to be turned on based on the second gate signal.

6. The pixel circuit of claim 1, wherein, in a third section, the second transistor is configured to be turned on based on the first gate signal.

7. The pixel circuit of claim 1, wherein, in a fourth section, the fourth transistor and the seventh transistor are configured to be turned on based on the third gate signal.

8. The pixel circuit of claim 1, wherein, in a fifth section and in a sixth section, the fourth transistor and the seventh transistor are configured to be turned on based on the third gate signal.

9. A display apparatus comprising:
a display unit comprising pixels respectively connected to corresponding scan lines, to corresponding emission control lines, and to corresponding data lines;
a scan driver configured to supply scan signals respectively through the scan lines;
an emission control driver configured to supply emission control signals respectively through the emission control lines;
a data driver configured to supply data voltages respectively through the data lines; and
a power supplier configured to supply voltages to the pixels,
wherein the pixels comprise:
a first transistor connected between a first power voltage line and a light-emitting element;
a second transistor connected between one of the data lines and a first node, and configured to be driven based on a first gate signal;
a third transistor connected between a reference voltage line and the first node, and configured to be driven based on a second gate signal;
a fourth transistor connected between an initialization voltage line and an anode of the light-emitting element, and configured to be driven based on a third gate signal;
a fifth transistor connected between the first power voltage line and the first transistor, and configured to be driven based on one of the emission control signals;
a sixth transistor connected between the first transistor and the light-emitting element, and configured to be driven based on the one of the emission control signals;
a seventh transistor connected between the first transistor and the initialization voltage line, and configured to be driven based on the third gate signal; and
an eighth transistor connected between the first power voltage line and the first transistor, and configured to be driven based on the second gate signal.

10. The display apparatus of claim 9, wherein the pixels further comprise:
a first capacitor connected to a first gate terminal of the first transistor and to a second terminal of the first transistor; and
a second capacitor connected to the first power voltage line and to a second gate terminal of the first transistor.

11. The display apparatus of claim 9, wherein, in a first section:
the third transistor and the eighth transistor are configured to be turned on based on the second gate signal; and
the fourth transistor and the seventh transistor are configured to be turned on based on the third gate signal.

12. The display apparatus of claim 9, wherein, in a first section:
the fourth transistor and the seventh transistor are configured to be turned on based on the third gate signal; and
the third transistor and the eighth transistor are configured to be in turned-off states.

13. The display apparatus of claim 9, wherein, in a second section, the third transistor and the eighth transistor are configured to be turned on based on the second gate signal.

14. The display apparatus of claim 9, wherein, in a third section, the second transistor is configured to be turned on based on the first gate signal.

15. The display apparatus of claim 9, wherein, in a fourth section, the fourth transistor and the seventh transistor are configured to be turned on based on the third gate signal.

16. The display apparatus of claim 9, wherein, in a fifth section and a sixth section, the fourth transistor and the seventh transistor are configured to be turned on based on the third gate signal.

17. An electronic device comprising:
a memory;
a processor configured to execute an application stored in the memory; and
a display module configured to receive and to process an image data signal and configured to output image information, and comprising:
a first transistor connected between a first power voltage line and a light-emitting element;
a second transistor connected between a data line and a first node, and configured to be driven based on a first gate signal;
a third transistor connected between a reference voltage line and the first node, and configured to be driven based on a second gate signal;
a fourth transistor connected between an initialization voltage line and an anode of the light-emitting element, and configured to be driven based on a third gate signal;
a fifth transistor connected between the first power voltage line and the first transistor, and configured to be driven based on an emission control signal;
a sixth transistor connected between the first transistor and the light-emitting element, and configured to be driven based on the emission control signal;
a seventh transistor connected between the first transistor and the initialization voltage line, and configured to be driven based on the third gate signal; and
an eighth transistor connected between the first power voltage line and the first transistor, and configured to be driven based on the second gate signal.

18. The electronic device of claim 17, wherein the display module further comprises:
a first capacitor connected to a first gate terminal of the first transistor and to a second terminal of the first transistor; and
a second capacitor connected to the first power voltage line and to a second gate terminal of the first transistor.

19. The electronic device of claim 17, wherein, in a first section:
the third transistor and the eighth transistor are configured to be turned on based on the second gate signal; and
the fourth transistor and the seventh transistor are configured to be turned on based on the third gate signal.

20. The electronic device of claim 17, wherein, in a first section:
the fourth transistor and the seventh transistor are configured to be turned on based on the third gate signal; and
the third transistor and the eighth transistor are configured to be in turned-off states.
